(19) United States
(12) Patent Application Publication
(10) Pub. No.: US 2024/0095467 A1
(43) Pub. Date: Mar. 21, 2024

(54) TRANSLATING WEB CONTENT USING ACCESSIBILITY INFORMATION

(71) Applicant: International Business Machines Corporation, Armonk, NY (US)

(72) Inventors: CHIH-YUAN LIN, New Taipei City (TW); Jin Shi, Ningbo (CN); Shu-Chih Chen, New Taipei City (TW); PEI-YI LIN, New Taipei City (TW); Chao Yuan Huang, Taipei (TW)

(21) Appl. No.: 17/932,681

(22) Filed: Sep. 16, 2022

(51) Int. Cl. G06F 40/47; G06F 40/49; G06F 40/58

(52) U.S. Cl. CPC G06F 40/47; G06F 40/49; G06F 40/58

(57) ABSTRACT

Translating applications to a target language includes extracting program integrated information (PII) to be translated and creating translation context datasets based on interpretation of accessibility information associated with particular strings of PII. Translation pairs include PII and corresponding context datasets for context-based translation of application components. A two-stage index contains PII strings for first stage lookup and context datasets for distinguishing duplicate PII strings as a second stage lookup. Real-time translation is facilitated by the two-stage index, which is established by translation pairs and resulting translations.

### BACKGROUND

The present invention relates generally to the field of translating web content and more particularly to translation of user interface strings in cached web pages.

When translating the language of text in a web page or software application having user interface elements, some text strings in the application may remain untranslated. These text strings, such as text for: (i) error messages, (ii) the log-in screen, and (iii) menu options, are called “user interface” (UI) strings. Some of the UI strings are user-visible and others are instructions that are not user-visible such as web accessibility initiative's (WAI) accessible rich internet applications (ARIA) roles indicating the function, structure, and/or relationship between the user-visible strings displayed on user interface.

Translation of UI strings affects how displayed product menus, buttons, and/or messages communicate with the user. User interfaces that are translated incorrectly can lead to incorrect operation. For example, product menus that are difficult to understand lead to unhappy users. A common practice in the domain of software UI translation is to extract the user-visible UI strings as PII (Program Integrated Information) strings and provide them to translation service providers for translation from the source language into a target language based on the PII string value(s).

### SUMMARY

In one aspect of the present invention, a method, a computer program product, and a system includes: identifying accessibility information associated with an original program integrated information (PII) string in a software application; creating a translation context dataset for the original PII string based on the accessibility information; generating a translation pair including the original PII string and the corresponding translation context dataset; receiving a translated PII string based on the translation pair; and storing the translation pair and translated PII string in a translation index.

In another aspect of the present invention, a method, a computer program product, and a system includes: identifying accessibility information associated with an original program integrated information (PII) string of a web application; creating a translation context dataset for the original PII string based on the accessibility information; locating the original PII string in a translation index including translation pairs, the translation pairs being various PII strings and corresponding context datasets; and determining an accurate translation for the original PII string by identifying in the translation index a matching context dataset to the translation context dataset, the matching context dataset associated with a translated PII string. The translated PII string is the accurate translation of the original PII string. The original PII string is associated with multiple translation context datasets in the translation index, each instance of the original PII string being associated with a unique translated PII string.

### BRIEF DESCRIPTION OF THE SEVERAL VIEWS OF THE DRAWINGS

FIG. 1 is a schematic view of a first embodiment of a system according to the present invention;

FIG. 2 is a schematic view of a machine logic (for example, software) portion of the first embodiment system;

FIG. 3 is a flowchart showing a first method performed, at least in part, by the first embodiment system; and

FIG. 4 is a flowchart showing a second method performed, at least in part, by the first embodiment system.

### DETAILED DESCRIPTION

Translating applications to a target language includes extracting program integrated information (PII) to be translated and creating translation context datasets based on interpretation of accessibility information associated with particular strings of PII. Translation pairs include PII and corresponding context datasets for context-based translation of application components. A two-stage index contains PII strings for first stage lookup and context datasets for distinguishing duplicate PII strings as a second stage lookup. Real-time translation is facilitated by the two-stage index, which is established by translation pairs and resulting translations. The present invention may be a system, a method, and/or a computer program product. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as translation context engine 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

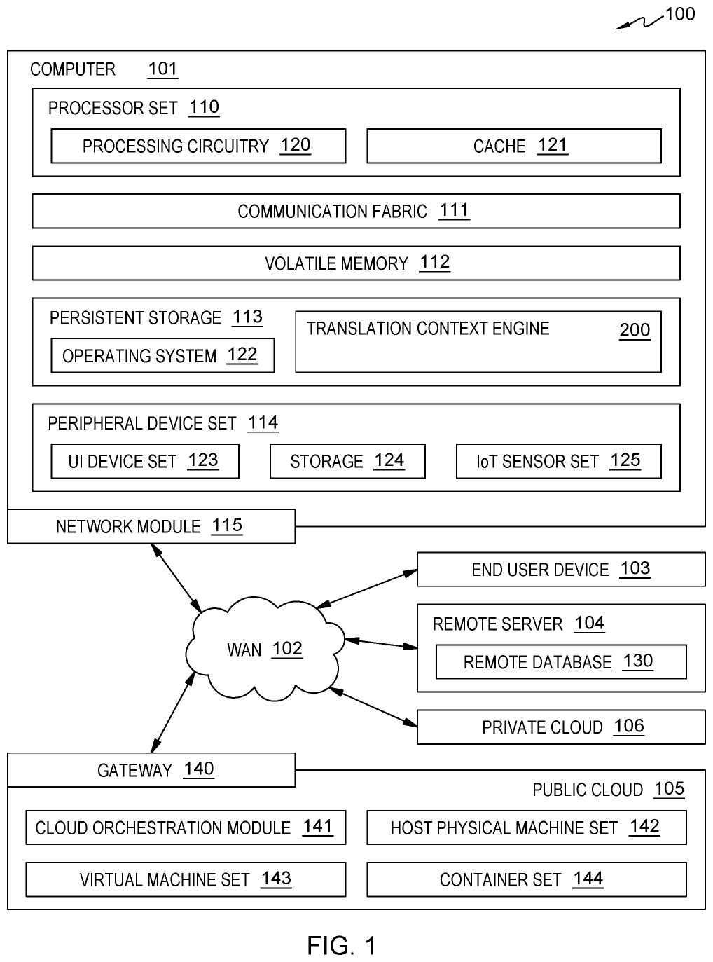

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The programs described herein are identified based upon the application for which they are implemented in a specific embodiment of the present invention. However, it should be appreciated that any particular program nomenclature herein is used merely for convenience, and thus the present invention should not be limited to use solely in any specific application identified and/or implied by such nomenclature.

US patent publication 2020/0097553 discloses a cognitive translation engine for translating PII translation requests embedded with PII derivation relationships. The cognitive translation engine can translate the PII text from a source language into a target language according to the information of PII context derivation structure received from the client side. The proposed system includes a cognitive translation service integrated with context sensitive derivations for determining PII relationship. Some embodiments of the present invention generate a translation index linking selected PII strings to context information identified in accessibility information provided with the interface source code. Further, selection of an appropriate translation of a given PII string includes matching the given PII string with PII instances in the index and matching the context information of each PII instance with the context of the given PII string. When a context match is identified, the corresponding PII translation is used to create a translated PII string from the given PII string.

Translation context engine 200 operates to translate web content in real time with reference to accessibility information associated with various program integrated information (PII) strings for context-based translations. A quick-reference translation index is generated for lookup of PII and corresponding context data collected from accessibility information. According to some embodiments of the present invention, the accessibility information is associated with a given PII string by being included in the user interface source code of the interface component corresponding to the given PII string.

Some embodiments of the present invention recognize the following facts, potential problems and/or potential areas for improvement with respect to the current state of the art: (i) users have a better experience when using software that is completely translated into the target language for which is it produced; (ii) providing context for translation of UI strings to a localization team improves the accuracy of the translation and the user experience with the application; (iii) program integrated information (PII) strings can be extracted on the fly through the mechanism called translation proxy; (iv) making up for poor translation by using TVT (translation verification test) requires additional time and processing to achieve a suitable result; (v) semantic role info can imply the context of a user interface component; and/or (vi) the semantic role info is often found in accessibility information.

When doing translations, translators will often translate PII strings directly in a translation workbench. There is almost no context information for translation reference, leading to incorrect translations or inaccurate translations. The user experience (UX) becomes worse as incorrect or incomplete translations are presented during use of the application. This condition can be improved by convention processes such as translation verification tests (TVT), which are time-intensive activities. An objective of the present invention is to identify existing context information of the PII strings as found in accessibility information to translators and subsequently to a translation index. Translation of the PII strings is more like to be correct when performed in view of context clues provided by accessibility information.

Some embodiments of the present invention are directed to providing rich, automated, context information for program integrated information (PII) strings submitted for translation. In that way, the PII strings are automatically translated correctly. Further, some embodiments of the present invention effectively reuse historic translations recorded for future translation processes.

Some embodiments of the present invention are directed to providing a high-quality translation proxy service by leveraging available accessibility technologies, such as web accessibility initiative's (WAI) accessible rich interne applications (ARIA) roles, also referred to as WAI-ARIA roles. to automatically provide the context information by linking it to the PII strings in the resource files. WAI-ARIA roles, or simply ARIA roles, indicate the function, structure, and relationship between the text information displayed on user interface. Further, ARIA roles provide semantic meaning to content, allowing screen readers and other tools to present and support interaction with object in a way that is consistent with user expectations of that type of object. ARIA roles can be used to describe elements that do not natively exist in HTML (hypertext markup language) or that exist but do not yet have full browser support.

Certain ARIA document structure roles such as presentation, toolbar, and tooltip, provide information on the document structure to assistive technologies such as screen readers because the equivalent native HTML tags may not be available. ARIA role types include, but are not limited to: (i) document structure roles; (ii) widget roles; (iii) composite widget roles; (iv) landmark roles; (v) live region roles; (vi) window roles; and (vii) abstract roles.

Some embodiments of the present invention are directed to performance of an efficient translation search that can be reused via a two-stage indexing approach based on the identified context information.

Some embodiments of the present invention are directed to a method that includes: (i) walking through a web application site via available web site crawling and analysis technologies; (ii) collecting the PII strings from the cached web pages; (iii) creating translation context by utilizing existing accessibility technologies to get the descriptions of each UI component by (a) using screen readers to provide a natural language description via natural language processing (NLP) technologies for each UI component based on the accessibility information embedded in the web pages such as the WAI-ARIA roles, state and properties, and the HTML “alt” attribute information, and (b) automating the process to perform screen-reading of the cached pages through technologies like headless browser, and (c) storing the description as the translation context of the corresponding PII strings; (iv) sending the PII strings and the translation context for translation of the PII strings. The translation context is attached so that the designated translator(s) can enhance the translation quality, or determine the translation more consistently with the original meaning.

Further, some embodiments of the present invention are directed to reuse of the translations by: (i) storing the translation with a two-stage indexing method including: (a) using the value of the source string, or PII string, for the first stage, and (b) using the translation context, or a mapping of the translation context to a feature space such as with the bidirectional encoder representation from transformers (BERT) language model, as the second stage index, where the translation context is highly representative in the meaning of the value of the source string (this data may be stored as triplets in the form (value, context, translation) as translation processes are competed). In that way, when a new web page is sent to the translation proxy server, the following actions are performed to look up a reliable translation of the PII strings: (a) retrieve the translation context as described above; (b) search the stored translation in a two-staged index; and (c) if the translation context and PII element match to a specified degree of similarity, apply the translation to related PII string. If the is no match, the PII string is sent to a translation agent with the translation context information attached.

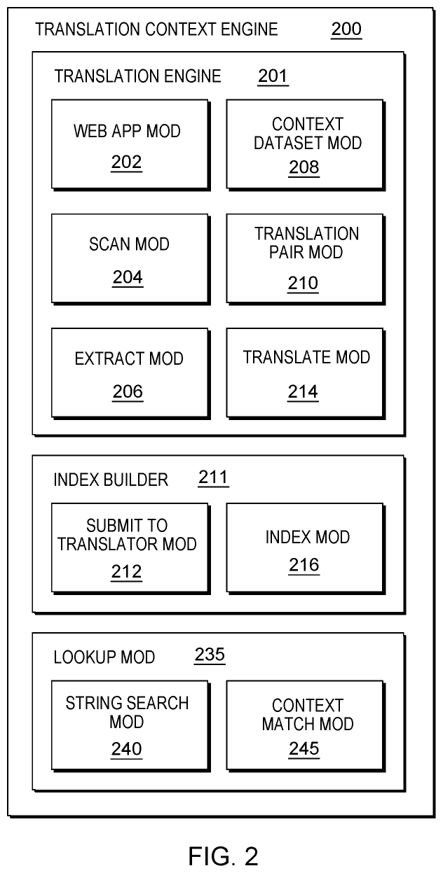

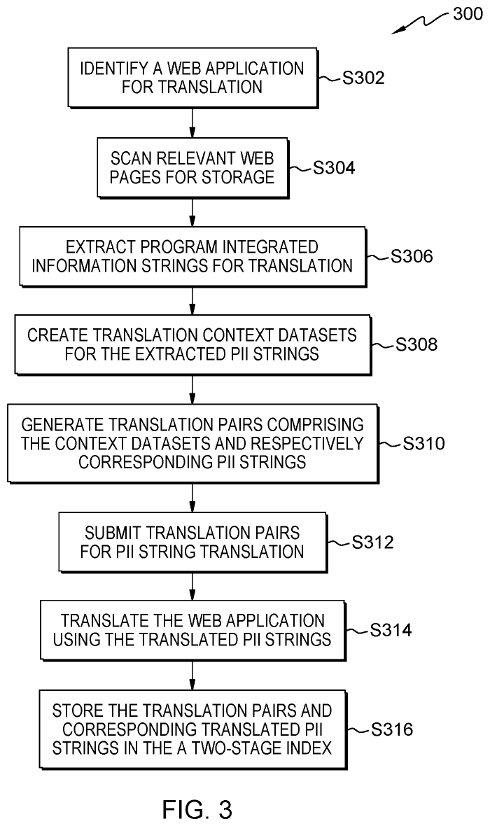

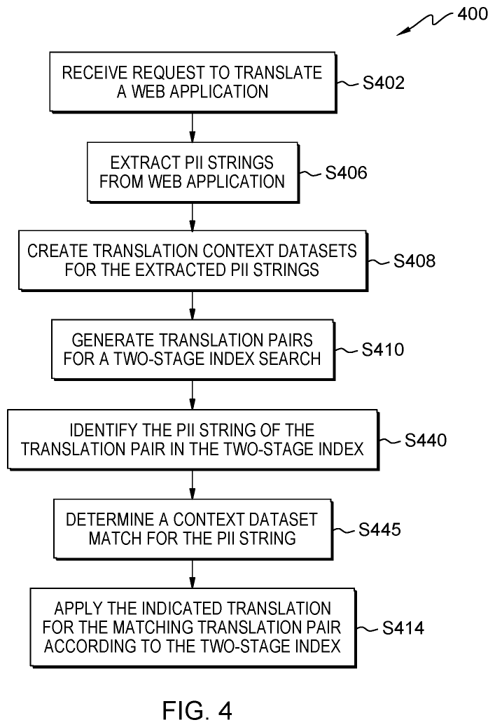

FIGS. 3 and 4 show flowchart 300 and 400 depicting methods performed according to the present invention. FIG. 2 shows program 200 for performing at least some of the method steps of flowcharts 300 and 400. Program 200 includes submodules translate engine 201, index builder 211, and lookup module 235. The translate engine includes common software module for performing both index building and translation lookup. The index builder includes software modules specific to building the translation index, often referred to herein as a two-stage index. The lookup module includes software modules specific to identifying appropriate translations of PII strings oftentimes in the form of a two-stage process of identifying the PII string in the index and selecting the translation based on associated context information.

Referring now to FIG. 3, the method according to flowchart 300 and associated software (FIG. 2) will now be discussed, over the course of the following paragraphs.

Processing begins at step S302, where web application module 202 identifies a web application for translation. In this example, the web application is identified online during use of the computer system presenting the web application via a web page. Alternatively, the web application is identified via a request for translation providing a link to the application to be translated.

Processing proceeds to step S304, where scan module 204 scans relevant web pages for storage and/or caching of the web pages. Upon identifying the web application for translation, the scan module operates to scan the web pages of the application in preparation to store the various pages and/or cache the web pages for later viewing. The scanned web pages may be only those relevant to a specific request received such as when the web application is identified during a browsing session. Relevant web pages are those pages being viewed or those pages having been viewed prior to a request to translate. According to some embodiments of the present invention the whole web application is relevant for translation purposes.

Processing proceeds to step S306, where extract module 206 extracts program integrated information (PII) strings for translation. Extracting the PII from the relevant portions of the application to be translated allows for translation of the particular PII of interest. The PII that is extracted may be related to dialog titles, button captions, and menus selectable in the application.

Processing proceeds to step S308, where context dataset module 208 creates translation context datasets for the extracted PII strings. Oftentimes the extracted PII strings will be associated with a set of accessibility information for use by screen readers or other accessibility devices using assistive technologies. The context dataset module creates the translation context datasets by reading the accessibility information associated with the various extracted PII strings. In that way, context information is created from pre-existing metadata stored with the PII strings. According to some embodiments of the present invention, reading the accessibility information includes translating the information into the target language by the accessibility device. In that way, language-specific context datasets are created in real time as needed for translation purposes without the need of preparing the context information in advance of receiving a translation request.

Processing proceeds to step S310, where translation pairs module 210 generates translation pairs comprising the context datasets and respectively corresponding PII strings. The translation pairs generated by the translation pairs module may be stored in a translation database for access by designated translators including machine translation engines. Each translation pair includes a PII string and its related translation context dataset, based on interpreted accessibility information for the untranslated user interface strings. Context datasets provide contextual clues for the translating service, but also provide a second-stage index element for a two-stage translation index created in step S316, below.

Processing proceeds to step S312, where submit to translator module 212 submits the translation pairs for translation of the PII strings. In this example, the translation pairs generated in step S310 are submitted to machine translation engines. According to some embodiments of the present invention, the translation pairs are submitted to a translation service provider, which may include providing a link to the digital location of the translation pairs. Alternatively, the submitting process is interrupted by an index review for possible matches, as described in flowchart 400 (FIG. 4), below.

Processing proceeds to step S314, where translate module 214 translates the web application using the translated PII strings. In this example, the web application is largely translated but for the PII strings that are extracted in step 306. Alternatively, the translation of the web application is ongoing, but includes adaptation of the translated PII strings during translation of the whole web application or the relevant portions thereof. Essentially, effective translation of the web application relies upon incorporation of the translated PII strings.

Processing ends at step S316, where index module 216 stores the translation pairs and corresponding translated PII strings in a two-stage index. As mentioned earlier, the translation pairs generated in step S310 are recorded for later use, or reuse as translation guides. In this example, the translation pairs are recorded to a two-stage index for use in translating other web applications on the fly, or in real time as the request for translation is received.

The operation of translation context module 200 as described herein may be performed in real time to allow prompt translation of software UI strings or entire web applications. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

Referring now to FIG. 4, the method according to flowchart 400 and associated software (FIG. 2) will now be discussed, over the course of the following paragraphs.

Processing begins at step S402, where web application module 202 receives a request to translate a web application. In this example, the web application is identified via a request for translation providing a link to the application to be translated. Alternatively, the web application is identified online during use of the computer system presenting the web application via a web page and the request is generated while viewing the web page.

Processing proceeds to step S406, where extract module 206 extracts program integrated information (PII) strings from the web application. Extracting PII strings may be performed responsive to the request received in step S402 when the request is directed to a pre-scanned set of cached web pages. Alternatively, the extracting process includes scanning the web pages of the application in preparation to store the various pages and/or cache the web pages for later viewing. The scanned web pages may be only those relevant to a specific request received such as when the web application is identified during a browsing session. Relevant web pages are those pages being viewed or those pages having been viewed prior to a request to translate. According to some embodiments of the present invention the whole web application is relevant for translation purposes.

Extracting the PII from the relevant portions of the application to be translated allows for translation of the particular PII of interest. The PII that is extracted may be related to dialog titles, button captions, and menus selectable in the application.

Processing proceeds to step S408, where context dataset module 208 creates translation context datasets for the extracted PII strings. Oftentimes the extracted PII strings will be associated with a set of accessibility information for use by screen readers or other accessibility devices using assistive technologies. The context dataset module creates the translation context datasets by reading the accessibility information associated with the various extracted PII strings. In that way, context information is created from pre-existing metadata stored with the PII strings. According to some embodiments of the present invention, reading the accessibility information includes translating the information into the target language by the accessibility device. In that way, language-specific context datasets are created in real time as needed for translation purposes without the need of preparing the context information in advance of receiving a translation request.

Processing proceeds to step S410, where translation pair module 210 generates translation pairs for a two-stage index search. The translation pairs generated by the translation pairs module may be stored in a translation database for access by designated translators including machine translation engines. Each translation pair includes a PII string and its related translation context dataset, based on interpreted accessibility information for the untranslated user interface strings. Context datasets provide contextual clues for cross-reference in a two-stage translation index, such as the one created in step S316 (FIG. 3).

Processing proceeds to step S440, where string search module 240 identifies the PII string of the translation pair in the two-stage index. In this example, the index for translating PII strings operates as a two-stage index with the first stage being the matching of the PII string in question. If the PII string is matched, then a second stage process is undertaken when multiple refences to the PII string are found. Further, the primary index (first-stage) to locate the translation is based on the PII string value itself. Alternatively, the hashed value of PII string is used as the index value.

Processing proceeds to step S445, where context match module 245 determines a context dataset match for the PII string. In this example, when there are multiple matches found via the first-stage index, the secondary index (second-stage) is then applied to determine the most appropriate translation. The index utilizes the context information associated with the found PII strings, which is further mapped to a feature space that is sensitive to its linguistic semantics. For example, the bidirectional encoder representation from transformers (BERT) language model may be applicable to identification of the appropriate translation. Semantic similarity can be calculated by measuring their distance in the feature space/vector space and can be served as the secondary index for translation search.

Processing ends at step S414, where translate module 214 applies the indicated translation for the matching translation pair according to the two-stage index. In this example, the translation of the web application is ongoing, but includes adaptation of the translated PII strings during translation of the whole web application or the relevant portions thereof. Alternatively, the web application is largely translated but for the PII strings that are extracted in step S406. Essentially, effective translation of the web application relies upon incorporation of the translated PII strings.

Further embodiments of the present invention are discussed in the paragraphs that follow.

Some embodiments of the present invention are directed to creating dynamic packages including program integration information (PII strings) with translation context obtained by the application of accessibility technologies to describe corresponding UI components. For example, the PII, such as dialog title, button caption, menu, and list, is collected from cached web pages for translation. Alternatively, application program code

Examples showing accessibility information follow. In a first example, the UI string “Close” is collected. The context for the UI string is that it is a button in the “Your personality details were successfully updated” dialog, as follows:

```
<div role=“dialog” aria-labelledby= “dialogTitle” aria-describedby=
“dialogDesc”>
  <h2 id=“dialogTitle”>Your personal details were successfully
updated</h2>
  <p id=“dialogDesc”>You can change your details at any time in the user
account section.</p>
  <button>Close</button>
</div>
```

In a second example, the UI string “Pick what type of jokes you like” is collected. The context for the collected UI string is that it is the subject of a “combobox” which has options including “Puns, Riddles, and Observations” as follows:

```
<label for=“jokes”>Pick what type of jokes you like</label>
<div class=“combo-wrap”>
  <input type=“text” id=“jokes” role=“combobox” aria-owns=“joketypes”
aria-autocomplete=“list” aria-ex
  <span aria-hidden=“true” data-trigger=“multiselect”></span>
  <ul id=“joketypes” role=“listbox”>
    <li class=“active” role=“option” id=“item1”>Puns</li>
    <li class=“option” role=“option” id=“item2”>Riddles</li>
    <li class=“option” role=“option” id=“item3”>Observations</li>
    <li class=“option” role=“option” id=“item4”>Knock-knock</li>
    <li class=“option” role=“option” id=“item5”>One liners</li>
  </ul>
</div>
```

Some embodiments of the present invention are directed to an automated process to perform screen-reading of the cached pages through technologies like headless browser and to store the description of the various UI components as the translation context of the corresponding PII strings. The textual information may be retrieved from a screen reader program interface or via logs.

According to some embodiments of the present invention, the identified translation context can is used for machine translation to boost the translation quality of few-word sentences on graphical user interfaces.

According to some embodiments of the present invention, the mapping of the translation context to a feature space such as with the bidirectional encoder representation from transformers (BERT) language model can serve to find the vector representation of the translation context of a source string. The appropriate translation may be found in a matching source string and context pair by calculating the distances among the searching targets in a database contained stored translations. The nearest target translation pair (within a pre-defined threshold) is determined to be the best matching translation.

Sometimes, a same source string would need a different translation according to its context. A threshold can be set to determine whether the source string will be stored as another translation or matches a currently stored translation. For example, the source string “close” could be an adjective or a verb depending on the context in which is it used in a given UI string. When translating the string “close,” the mapping can be used to select the most appropriate translation as illustrated in Table 1.

TABLE 1
Two-stage index for translation support.

| SOURCE | | | | | |
|---|---|---|---|---|---|
| STRING | SS | TRANSLATION | TC | LO- | TRANS- |
| (SS) | INDEX | CONTEXT (TC) | INDEX | CALE | LATION |
| Close | 2DFF | It is a button in | (x, y, z) ± | Chile | Cerrar |
| | | “Your personality | T | | |
| | | details were | | | |
| | | successfully | | | |
| | | updated dialog.” | | | |

Some embodiments of the present invention are directed to using accessibility information included in a user interface source code to generate real-time program integrated information with translation context for designated translators to optimize the translation quality.

Some embodiments of the present invention are directed to generate a two-stage index using translation context and source string pairs to find the most appropriate translation when the state index (e.g., the value of the source string) has multiple occurrences in a lookup table.

Some embodiments of the present invention may include one, or more, of the following features, characteristics and/or advantages: (i) cost effective and high quality translation; (ii) no need to create program integrated information resource files and to prepare the context information in advance; (iii) the dynamically generated context information can be used as reference either for human translation or machine translation to optimize the translation quality; (iv) prompt and precise translation mapping; (v) leverages the fully developed screen reader technology; (vi) context information enhances the translation quality when localizing an application or a user interface; and/or (vii) precise translation mapping and translation memory reuse based on the contextual similarities.

Some embodiments of the present invention are directed to using accessibility information included in the rendered user interface source code to dynamically generate real-time program integrated information (PII) strings with the corresponding context information. The accessibility information is acquired by leveraging assistive technologies such as screen readers that provide descriptions in a specified language for each UI element.

The PII strings and context information datasets are generated on-the-fly and can be quickly provided to a translation service provider for translation by machine translation (MT) engines.

According to some embodiments of the present invention, context information is used to create a second-stage index for locating an appropriate language translation in a translation database when the first stage index has multiple occurrences, the first stage index being based on the source string value. The translations are stored in the translation database along with the context information and the source string value(s). In an example embodiment, the primary index (first-stage index) to locate the translation is based on the source string value itself. Generally, the hashed value of source string is used as the index value.

When there are multiple primary matches found via the first-stage index, the secondary index (second-stage index) is then applied to find the most appropriate translation based on the associated context information. The index utilizes the context information of the source code strings, which may be further mapped to a feature space that is sensitive to its linguistic semantics such as the BERT features. The semantic similarity can be calculated by measuring their distance in the feature space/vector space and can be served as the secondary index for translation search.

Some embodiments of the present invention are directed to on-the-fly translation of UI strings by leveraging accessibility information as context-based quality booster. Alternatively, some embodiments of the present invention are directed to on-the-fly translation of UI strings by leveraging accessibility information as an indexing base in a two-stage index.

Some embodiments of the present invention utilize accessibility information, gathered from automated screen reader invocation, as the context information of the corresponding UI strings

Some embodiments of the present invention are directed to a translation memory search method utilizing the accessibility information as context data as a second-layer index base, the first layer being the source code string.

Some embodiments of the present invention leverage an accessibility tag as the context information. The accessibility tag provides context that is different from the context of the hyperlinks on the web page.

Some embodiments of the present invention are directed to a method for matching similar context information to find the best translation in multiple translation candidates using recorded translation triples (value, context, translation).

Some embodiments of the present invention are directed to a method to build up relationship information with context-sensitive derivations as well as to a process for a translation engine to get the most suitable translation.

Some embodiments of the present invention leverage accessibility info to generate the corresponding context information and further use the context information to create the second-stage index.

Clause 1. The computer-implemented method for creating a translation index for a software application, the method comprising: identifying accessibility information associated with an original program integrated information (PII) string in a software application; creating a translation context dataset for the original PII string based on the accessibility information; generating a translation pair including the original PII string and the corresponding translation context dataset; receiving a translated PII string based on the translation pair; and storing the translation pair and translated PII string in a translation index.

Clause 2. The method of clause 1, further comprising submitting, to a translator, the translation pair for translation of the original PII string.

Clause 3. The method of any of previous clauses 1 and 2, further comprising: translating the software application from a first language to a target language, including the translated PII string.

Clause 4. The method of any of previous clauses 1-3, wherein the original PII string is written in a first language and wherein the translation context dataset is created in a target language for which the original PII string is to be translated.

Clause 5. The method of any of previous clauses 1-4, wherein the translation index is a two-stage index with a primary index being the original PII string and a secondary index being the translation context dataset.

Clause 6. The method of any of previous clauses 1-5, further comprising: identifying the software application for translation; and scanning the web pages of the software application for the original program integrated information (PII) string.

Clauses 7. A computer-implemented method for translating program integrated information (PII) strings in software applications, the method comprising: identifying accessibility information associated with an original program integrated information (PII) string of a web application; creating a translation context dataset for the original PII string based on the accessibility information; locating the original PII string in a translation index including translation pairs, the translation pairs being various PII strings and corresponding context datasets; and determining an accurate translation for the original PII string by identifying in the translation index a matching context dataset to the translation context dataset, the matching context dataset associated with a translated PII string. The translated PII string is the accurate translation of the original PII string. The original PII string is associated with multiple translation context datasets in the translation index, each instance of the original PII string being associated with a unique translated PII string.

Clause 8. The method of clause 7, wherein the original program integrated information (PII) string is extracted while displaying the web application and wherein determining the accurate translation occurs in real time upon request while displaying the web application.

Clause 9. The method of any of clauses 7 and 8, wherein identifying the matching context dataset includes: calculating semantic similarity of the matching context information to the translation context information; and determining a match to the translation context information by the semantic similarity meeting a threshold level of similarity. The translation index maps the matching context information to a feature space that is sensitive to linguistic semantics.

Clause 10. The method of any of clauses 7-9, further comprising: translating the web application from a first language to a target language, including the translated PII string.

Clause 11. The method of any of clauses 7-10, wherein the translation index is a two-stage index with a primary index being the original PII string and a secondary index being the translation context dataset.

Clause 12. The method of any of clauses 7-11, further comprising: receiving a request to translate the web application; and scanning web pages of the web application to identify the original program integrated information (PII) string.

Some helpful definitions follow:

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method for creating a translation index for a software application, the method comprising:
identifying accessibility information associated with an original program integrated information (PII) string in a software application;
creating a translation context dataset for the original PII string based on the accessibility information;
generating a translation pair including the original PII string and the corresponding translation context dataset;
receiving a translated PII string based on the translation pair; and
storing the translation pair and translated PII string in a translation index.

2. The method of claim 1, further comprising:
submitting, to a translator, the translation pair for translation of the original PII string.

3. The method of claim 1, further comprising:
translating the software application from a first language to a target language, including the translated PII string.

4. The method of claim 1, wherein:
the original PII string is written in a first language; and
the translation context dataset is created in a target language for which the original PII string is to be translated.

5. The method of claim 1, wherein the translation index is a two-stage index with a primary index being the original PII string and a secondary index being the translation context dataset.

6. The method of claim 1, further comprising:
identifying the software application for translation; and
scanning the web pages of the software application for the original program integrated information (PII) string.

7. A computer-implemented method for translating program integrated information (PII) strings in software applications, the method comprising:
identifying accessibility information associated with an original program integrated information (PII) string of a web application;
creating a translation context dataset for the original PII string based on the accessibility information;
locating the original PII string in a translation index including translation pairs, the translation pairs being various PII strings and corresponding context datasets; and
determining an accurate translation for the original PII string by identifying in the translation index a matching context dataset to the translation context dataset, the matching context dataset associated with a translated PII string;
wherein:
the translated PII string is the accurate translation of the original PII string; and
the original PII string is associated with multiple translation context datasets in the translation index, each instance of the original PII string being associated with a unique translated PII string.

8. The method of claim 7, wherein the original program integrated information (PII) string is extracted while displaying the web application; and
determining the accurate translation occurs in real time upon request while displaying the web application.

9. The method of claim 7, wherein identifying the matching context dataset includes:
calculating semantic similarity of the matching context information to the translation context information; and
determining a match to the translation context information by the semantic similarity meeting a threshold level of similarity;
wherein:
the translation index maps the matching context information to a feature space that is sensitive to linguistic semantics.

10. The method of claim 7, further comprising:
translating the web application from a first language to a target language, including the translated PII string.

11. The method of claim 7, wherein the translation index is a two-stage index with a primary index being the original PII string and a secondary index being the translation context dataset.

12. The method of claim 7, further comprising:
receiving a request to translate the web application; and
scanning web pages of the web application to identify the original program integrated information (PII) string.

13. A computer system for translating program integrated information (PII) strings, the computer system comprising:
a processor set; and
a computer readable storage medium;
wherein:
the processor set is structured, located, connected, and/or programmed to run program instructions stored on the computer readable storage medium; and
the program instructions which, when executed by the processor set, cause the processor set to translate program integrated information (PII) strings by:
identifying accessibility information associated with an original program integrated information (PII) string of a web application;
creating a translation context dataset for the original PII string based on the accessibility information;
locating the original PII string in a translation index including translation pairs, the translation pairs being various PII strings and corresponding context datasets; and
determining an accurate translation for the original PII string by identifying in the translation index a matching context dataset to the translation context dataset, the matching context dataset associated with a translated PII string;
wherein:
the translated PII string is the accurate translation of the original PII string; and
the original PII string is associated with multiple translation context datasets in the translation index, each instance of the original PII string being associated with a unique translated PII string.

14. The computer system of claim 13, wherein:
the original program integrated information (PII) string is extracted while displaying the web application; and
determining the accurate translation occurs in real time upon request while displaying the web application.

15. The computer system of claim 13, wherein identifying the matching context dataset includes:
calculating semantic similarity of the matching context information to the translation context information; and
determining a match to the translation context information by the semantic similarity meeting a threshold level of similarity; and
wherein:
the translation index maps the matching context information to a feature space that is sensitive to linguistic semantics.

16. The computer system of claim 13, further comprising:
translating the web application from a first language to a target language, including the translated PII string.

17. The computer system of claim 13, wherein the translation index is a two-stage index with a primary index being the original PII string and a secondary index being the translation context dataset.

18. The computer system of claim 13, further comprising:
receiving a request to translate the web application; and
scanning web pages of the web application to identify the original program integrated information (PII) string.
